(19) United States
(12) Patent Application Publication
(10) Pub. No.: US 2020/0355158 A1
(43) Pub. Date: Nov. 12, 2020

(54) METHODS AND APPARATUS FOR GENERATING ELECTRICITY FROM WIND POWER

(71) Applicant: Nigel P. Cook, Jamul, CA (US)

(72) Inventor: Nigel P. Cook, Jamul, CA (US)

(21) Appl. No.: 16/868,369

(22) Filed: May 6, 2020

Related U.S. Application Data
(60) Provisional application No. 62/846,553, filed on May 10, 2019.

(51) Int. Cl. F03D 3/02; F03D 3/00; F03D 3/06; F03D 3/04; F03D 15/00; F03D 7/06; F03D 9/00

(52) U.S. Cl. CPC F03D 3/02; F03D 3/005; F03D 3/068; F03D 9/255; F03D 15/00; F03D 7/06; F03D 9/007; F03D 3/0418

(57) ABSTRACT

A system for generating power from wind and/or solar energy. The system comprises an array of rotors exposed and configured to capture wind power. The array of rotors is installed or set in a rotor panel having members that carries each of rotor of the array of rotors in a freewheeling state. The system further comprises a generator connected to a subset of the rotors of the array of rotors. The generator is configured to generate electric power from the subset of the rotors when the rotors rotate at a speed exceeding a threshold rotational speed. The system further comprises a converter connected to an output of the generator. The converter is configured to convert the electric power into another electric power suitable for transmission to and consumption by an electric consumer.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD OF THE INVENTION

The present disclosure relates generally to converting wind to electricity, and more specifically, to converting wind to electricity in a compact, hermetically sealed system.

### DESCRIPTION OF THE RELATED ART

Existing turbines generate electricity from wind, etc. Such turbines generally have rotor diameters of between 40 to 90 meters. Wind power intercepted by turbines is proportional to the square of blade length of the turbines. Energy created is based on an economy of scale. Thus, large diameter (for example, greater than 40 meter diameter) rotors 202 for electricity generating turbines are used over smaller diameter rotors 202. This is because electricity-generating turbines with larger diameter rotors 202 will create electricity more efficiently than electricity generating turbines with smaller diameter rotors 202.

A turbine having a rotor diameter between 40 and 90 meters may be about 35% efficient. A theoretical efficiency for a single wind turbine generally used in calculations is about 59% (the Betz limit). However, such turbines may only generate power 13.5% of the time because of a corresponding cut-in speed of 10-15 meter/second (m/s). The cut-in speed corresponds to a wind speed needed to cause the rotors 202 of the turbine to rotate. The 10-15 m/s cut-in wind speeds rank as #6 on the Beaufort scale and correspond to a strong breeze that causes large branches to sway and that makes umbrellas difficult to use.

### SUMMARY

The systems, methods, and devices described herein each have several aspects, no single one of which is solely responsible for its desirable attributes. Without limiting the scope of this disclosure, several non-limiting features will now be described briefly.

A system for generating power from wind is provided. The system comprises an array of rotors exposed and configured to capture wind power. The array of rotors is installed or set in a rotor panel having members that carries each of rotor of the array of rotors in a freewheeling state. The system further comprises a generator connected to a subset of the rotors of the array of rotors. The generator is configured to generate electric power from the subset of the rotors when the rotors rotate at a speed exceeding a threshold rotational speed. The system further comprises a converter connected to an output of the generator. The converter is configured to convert the electric power into another electric power suitable for transmission to and consumption by an electric consumer.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of disclosure.

FIG. 1 shows components generally embodied in a wind turbine having a rotor diameter.

FIG. 2A shows a structural diagram of a phased array wind turbine panel in accordance with an exemplary embodiment of the invention.

FIG. 2B shows a side view of cones used to capture and direct wind through rotors 202 of the phased array wind turbine panel of FIG. 2A.

FIG. 2C shows a structural diagram for an alternate embodiment of the phased array wind turbine panel of FIG. 2A with different gearing options for coupling the rotors 202 depicted in accordance with an exemplary embodiment of the invention.

FIG. 2D shows a structural diagram for an alternate embodiment of the phased array wind turbine panel with replaceable multi-rotor spiral columns.

FIG. 3A shows a perspective view of a plurality of wind array panels placed beside solar panels in a rooftop installation in accordance with an exemplary embodiment of the invention.

FIG. 3B shows a front view of a single row of wind turbines of FIG. 3A in accordance with an exemplary embodiment of the invention.

FIG. 3C shows a front view of a single wind turbine of FIG. 3B having an alignment tail and configured to rotate according to a prevailing wind in accordance with an exemplary embodiment of the invention.

FIG. 3D shows an alignment of the phased array wind turbine panel relative to the ground and wind direction in accordance with an exemplary embodiment of the invention.

FIG. 4A shows a layout of a staircase or stadium seating arrangement of rotors 202 in the phased array wind turbine panel in accordance with an exemplary embodiment of the invention.

FIG. 4B shows a layout of a vertical sub-unit arrangement of the rotors 202 in the phased array wind turbine panel in accordance with an exemplary embodiment of the invention.

FIG. 4C shows a layout of a crisscross staircase or stadium seating arrangement of the rotors 202 in the phased array wind turbine panel in accordance with an exemplary embodiment of the invention.

FIG. 5A is a structural diagram that shows mechanical components of the phased array wind turbine panel 200 of FIG. 2A in accordance with an exemplary embodiment of the invention.

FIG. 5B is a block diagram that shows electrical components of the phased array wind turbine panel 200 of FIG. 2A in accordance with an exemplary embodiment of the invention.

FIG. 6 is an equivalent circuit diagram representing a panel generator electrically, where Rs is the resistance of the generator windings plus the power cable, and RL is the resistance of the load, in accordance with an exemplary embodiment of the invention.

### DETAILED DESCRIPTION

The features, aspects and advantages of the present disclosure will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

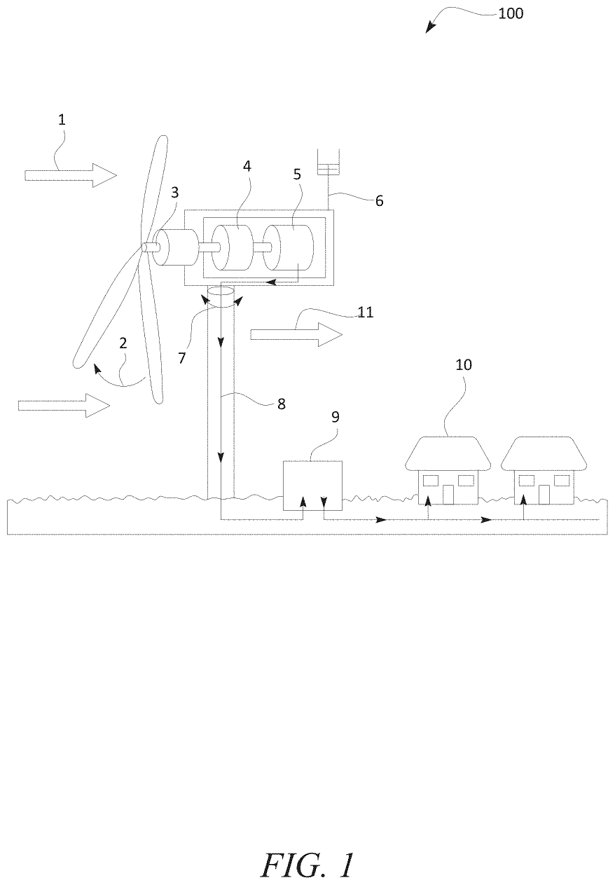

As noted above, FIG. 1 is a diagram that shows general components of a wind turbine system. Wind 1 (moving air that contains kinetic energy) blows toward the turbine's rotor blades 2. The rotors 202 spin around as freewheeling spinners, capturing some of the kinetic energy from the wind, turning a central drive shaft 3 that supports the rotors 202. Although the outer edges of the rotor blades 2 move very fast, the central drive shaft 3 turns slowly in comparison. in most large modern turbines (as shown in FIG. 1), the rotor blades 2 can swivel on a hub (not shown) coupled to the central drive shaft 3 so the rotor blades 2 meet the wind at the best angle (or “pitch”) for harvesting energy. Thus, the rotors 202 may comprise a pitch control mechanism. On such turbines, small electric motors or hydraulic rams in the hub swivel the rotor blades 2 back and forth under precise electronic control. On smaller turbines, the pitch control may be mechanical. Some turbines (large and/or small) have fixed rotors 202 and no pitch control at all.

Inside a nacelle (a main body of the turbine sitting on top of the tower and behind the rotor blades 2), a gearbox 4 converts the low-speed rotation of the drive shaft 3 (for example, 16 revolutions per minute, RPM) into a high-speed (for example, 1600 rpm) rotation fast enough to drive a generator 5 efficiently. The generator 5, which may be disposed following the gearbox 4, takes kinetic energy from the spinning drive shaft 3 and the gearbox 4 and turns the mechanical input 208 into electrical energy. Running at maximum capacity, a typical 2 MW turbine generator 5 will produce 2 million watts of power at about 700 volts. Anemometers 6 (automatic speed measuring devices) and wind vanes on the back of the nacelle provide measurements of the wind speed and direction. Using these measurements, the entire top part of the turbine (the rotor and nacelle) can be rotated by a yaw motor 7, mounted between the nacelle and the tower, so it faces directly into the oncoming wind 1 and captures the maximum amount of energy. If the wind is too fast or turbulent, brakes may be applied to stop the rotors 202 from turning (for safety reasons). The brakes may also applied during routine maintenance. The electric current 8 produced by the generator 5 may flow through a cable running down through the inside of the turbine tower. A step-up transformer 9 may convert the electricity to about 50 times higher voltage so it can be transmitted efficiently to the power grid 10 (or to nearby buildings or communities). If the electricity is flowing to the grid 10, the electricity may be converted to an even higher voltage (130,000 volts or more) by a substation nearby, which services many turbines. Thus, homes attached to the grid 10 are able to enjoy clean, green energy: the turbine has produced no greenhouse gas emissions or pollution as it operates. Wind 11 carries on blowing past the turbine, but with reduced speed and energy and more turbulence (since the turbine has disrupted its flow).

To avoid interference into the turbine panel by insects or animals, such as birds or bats, it may be desirable to introduce an audio (e.g., sound waves) and/or visual deterrent (e.g., solar reflectors or lighting) on each panel. To minimize interference of such audio or visual deterrents with the environment, such deterrent may be activated using a timer or other detector, such as infrared or radar, so it is activated when birds or bats are in the vicinity of the panel.

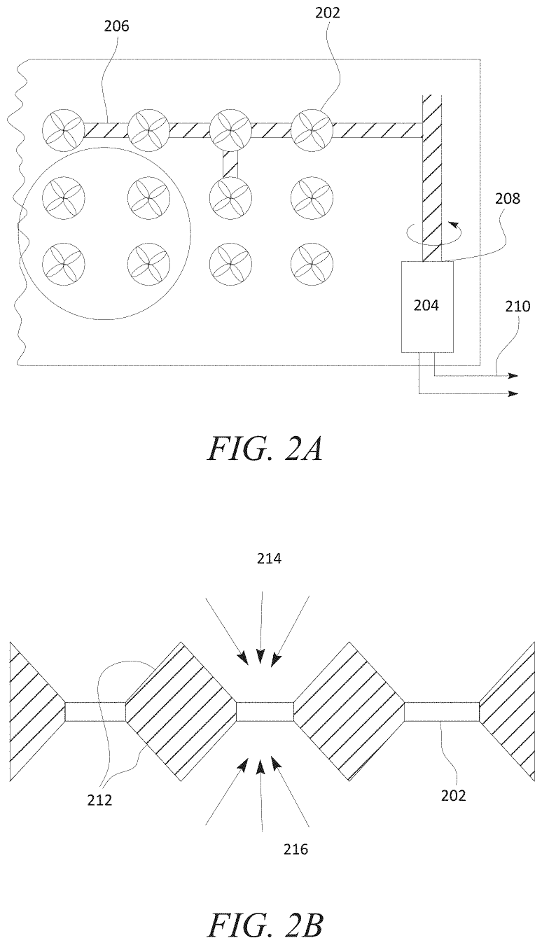

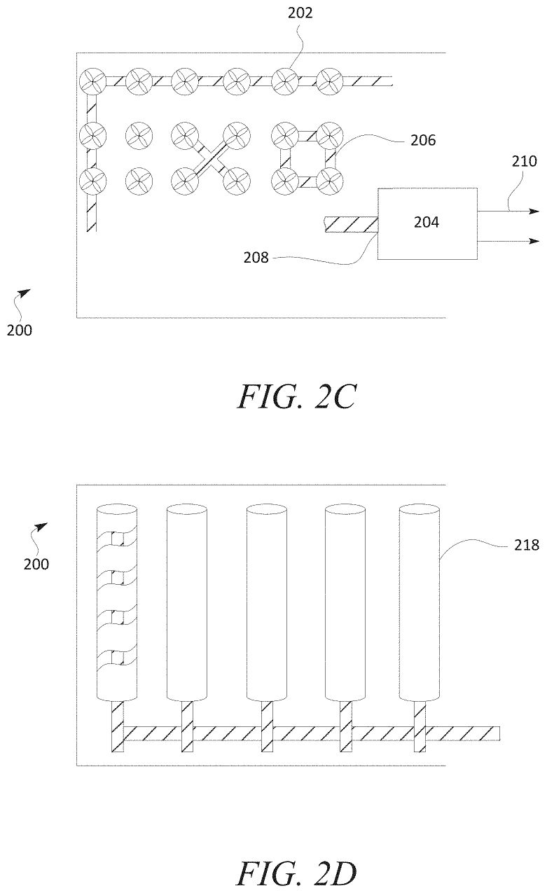

FIG. 2A shows a structural diagram of a phased array wind turbine panel 200 according to an exemplary embodiment. The phased array wind turbine panel 200 includes a plurality of rotors 202, an in-panel generator, mechanical couplings that couple the rotors 202 and the in-panel generator, and an electrical power output 210. The phased array wind turbine panel 200 may have an equivalent blade length as the wind turbine of FIG. 1. For example, a sum of all the individual blades of the rotors 202 of the phased array wind turbine panel 200 may be similar to the blade length of the wind turbine 204 of FIG. 1. FIG. 2B shows a side view of cones positioned between the rotors 202 and used to capture and direct wind through rotors 202 of the phased array wind turbine panel 200 of FIG. 2A. As shown, the cones 212 encircle each and every rotor 202 of the phased array wind turbine panel 200. The cones 212 act as to channel more wind (similar to vents founds in sails) than would be experienced by the rotors 202 without the conical collectors 212. As shown, a downdraft 214 and updraft 216 of air can be advantageously generated and/or channeled by the cones 212. The intercepted wind is focused or channeled to the rotors 202 due to the cone-collecting form-factor design of the panel.

In one embodiment, it is desirable to have a small wind turbine that is “effectively” large, e.g., where it's effect is maximized. For instance, a small rotor 202 will have an associated low-cut in speed and can harness all wind speeds from a breath to a gale. A very small blade length turbine, however, may or may not generate any usable electric power. In one embodiment, the wind 1 hits the array of rotors 202 of such small wind turbines, which work cooperatively and, therefore, have a large “effective” or equivalent blade length to maximize power generation. And so, the design in such an embodiment allows capitalizing on two parameters that have been at odds with one another.

The rotors 202 convert the intercepted wind into mechanical energy outputs for further conversion into electrical energy outputs. A total output of the phased array wind turbine panel 200 may be maximized by summing the mechanical energy outputs generated from each rotor of the phased array wind turbine panel 200. For example, the energy products from each rotor that are in-phase may be constructively summed. Thus, the total output generated (for example, at the input 208 of the in-panel generator) corresponds to a collection of the product of all rotors 202 of the phased array wind turbine panel 200 that operate cooperatively.

In some embodiments, neighboring rotors 202 of the phased array wind turbine panel 200 may be synchronized and may, thus, generate in-phase mechanical energy outputs for summing. For example, external adjacent near-field rotor air-coupling or mechanical coupling may exist between rotors 202 of the phased array wind turbine panel 200. The near-field air coupling may include when the airflow of one rotor creates a vortex or similar force that causes a neighboring rotor to move. The mechanical coupling may include internal panel gear coupling. Either or both of the near field air coupling and the mechanical coupling may synchronize the rotors 202 of the panel to operate together constructively and/or in-step. Thus, when the wind causes the rotors 202 to rotate, the rotors 202 of the phased array wind turbine panel 200 may work together to generate the total output. As noted above, the total rotor output is a mechanical input 208 for the in-panel generator (or an external generator coupled to the phased array wind turbine panel 200). In some embodiments, the in-panel generator is built into the phased array wind turbine panel 200. In one embodiment, it may be desirable to capture exhausts outside the near field to prevent unnecessary loading on the wind source.

As described above, the rotors 202 of the phased array wind turbine panel 200 are smaller than the rotor of the wind turbine 204 of FIG. 1. One benefit of the smaller size relates to the cut-in speed of the smaller rotors 202 of the phased array wind turbine panel 200. The cut-in speed of the rotor generally refers to the speed at which the rotor first starts to rotate and generate mechanical or electrical power. The larger the rotors, the faster the wind speed needed to set the rotors into motion. The rotor of the small rotors 202 of the phased array wind turbine panel 200 may have a smaller cut-in speed as compared to the rotors 202 having rotor diameters of 10 m or greater of FIG. 1. The cut-in speed of the rotors 202 of the phased array wind turbine panel 200 may be sufficiently low such that the slightest air movements (for example, wind speeds of between 1-5 m/s) will cause the rotors 202 to rotate and/or set the rotors 202. into motion. Thus, the smaller rotor size and the corresponding lower cut-in speed will cause the phased array wind turbine panel 200 to generate energy at lower wind speeds than the wind turbine of FIG. 1. Accordingly, the phased array wind turbine panel 200 may generate energy at more times than the wind turbine of FIG. 1. For example, the phased array wind turbine panel 200 may generate energy at times when the wind speeds are less than the cut-in speed for the wind turbine of FIG. 1 but greater than or equal to the cut-in speed for the rotors 202 of the phased array wind turbine panel 200.

In view of such differences, the phased array wind turbine panel 200 may have an efficiency of approximately 44% (compared to the efficiency of 35% for the wind turbine of FIG. 1). However, even with the efficiency of 35%, a 1-square meter size phased array wind turbine panel 200 may generate 15 watts at a wind speed of 5 m/s. The 5 m/s wind speed is #3 on the Beaufort scale, corresponding to a gentle breeze that causes leaves and small twigs to move and light flags to extend. At a 10 m/s wind speed, the 1-square meter size phased array wind turbine panel 200 generates 125 watts. The 10 m/s wind speed is #5 on the Beaufort scale, corresponding to a fresh breeze that causes small trees to sway and waves to break on inland waters. Thus, the phased array wind turbine panel 200 may generate usable power at wind speeds that would barely or not even cause the wind turbine of FIG. 1 to rotate.

In mechanical systems such as the phased array wind turbine panel 200, a larger amount of energy is generally needed to set the mechanical system into motion as compared to the amount of energy that is generally needed to sustain the motion. For example, a car generally has a lower city fuel efficiency because city environments generally have more stop-and-go events while having a higher freeway efficiency because less fuel is needed to sustain the momentum of the vehicle. Similar constraints apply to the phased array wind turbine panel 200. When a wind sensor of the phased array wind turbine panel 200 picks up a steady source (for example, a steady wind above a particular wind speed), the in-panel generator is activated as a motor. The in-panel generator may generally be used to convert the mechanical power of the rotors 202 to electricity but may also operate in reverse to initiate rotation of the rotors 202. When activated as the motor, the in-panel generator may be powered by a rechargeable in-panel charge storage device (for example, a capacitor or battery). The wind sensor, corresponding control electronics, and the charge storage may be optional for the phased array wind turbine panel 200.

The phased array wind turbine panel 200 described herein may reference rooftop installations embodiments as examples. However, it will be understood that the phased array wind turbine panel 200 may be implemented in various other installation embodiments, including ground level, on vehicles, in replacement of larger turbines, on ground or building/structure supporting structures, on land or nature features, and so forth. In one embodiment, the wind turbine panel 200 may be installed in or nearby roadside emergency phone locations. In that case, smaller panels and smaller charge storage will be needed with wind panels as they are often working (i.e., operating) day and night driven by naturally occurring wind or generated wind from passing cars. In another embodiment, the wind turbine panel 200 may be built as a back-pack sized panel that can be placed to capture wind and at least one cord that unwraps to supply two power outlets for use in lighting, heating, charging, etc. This form factor can be quite advantageous to campers, hikers, homeless, etc.

### Phased Array Wind Turbine Panels and Solar Panels

A typical roof-mounted solar panel has a size of approximately 72×39 inches, which equates to an area of approximately 1.935 m2. The solar panel may generate 250 watts for 4 hours per day, or 1 kilowatt-hour per day. For the remainder of the day, the solar panel may generate negligible, if any, power. For example, the solar panel may not generate power at night or when the sun is obstructed by clouds, trees, dust, and so forth.

The phased array wind turbine panel 200 may be installed in installations (for example on rooftops) similar to the roof-mounted solar panels. In comparison to the solar panel, however, the phased array wind turbine panel 200 of similar size (or two 1-square meter phased array wind turbine panels 200 described above) may generate 30 watts of power at 5 m/s wind speeds and 250 watts of power at 10 m/s wind speeds. Thus, the phased array wind turbine panel 200 may generate power at the same levels as the solar panel when the phased array wind turbine panel 200 is exposed to fresh breeze wind speeds (10 m/s). In contrast to the solar panel, where the solar panel energy output may be limited to times of day and when the sun is unobstructed, the phased array wind turbine panels 200 may generate electricity regardless of the time of day and regardless of sun obstructions. Accordingly, the phased array wind turbine panels 200 may be used in conjunction with the solar panel to add power production diversity and enable power generation regardless of time of day and sunlight conditions.

The phased array wind turbine panel 200 may be both physically and electrically compatible with existing roof-mounted solar panels. This means that the phased array wind turbine panels 200 may have similar frame structures to enable interconnectivity and interchangeability of the phased array wind turbine panels 200 and the roof-mounted solar panels in installations. Furthermore, the electrical outputs of the phased array wind turbine 200 and the solar panels may be compatible to allow use of both panels in hybrid wind/solar systems that feed a single electrical input for a house or building. For example, in some embodiments of hybrid wind/solar systems, the mechanical output of the phased array wind turbine panels 200 may be coupled to a dynamo to generate a pulsating DC output. The pulsating DC output can then be coupled with the DC output of the solar panels to feed an inverter that converts the DC to household AC power that is fed to the structure. In one embodiment, the inverter may be built in one or more solar panels to convert pulsating DC output to AC, and a built-in generator to produce AC. In one embodiment, a solar panel that is adjacent to a wind panel is configured to channel wind to the wind panel, and the wind panel has mirrors to redirect sunlight to the solar panel. This arrangement works well in the hybrid wind/solar systems whereby each panel type (e.g., solar) aids or enhances power generation by the other panel type (e.g., wind). In one embodiment, a hybrid solar/wind panel may be integrated structurally, e.g., the housing of the rotors 202 and flat or other surfaces of the wind panel may comprise photovoltaic (PV) material so that a single panel provides both wind and solar energy. PV material used in photovoltaic devices usually comprise silicon (monocrystalline, polycrystalline or amorphous), gallium arsenide, metal chalcogenides and organometallics, and/or any other material that is suitable for generating electric power from solar energy.

Alternatively, or additionally, in some embodiments of hybrid wind/solar systems, the mechanical output of the phased array wind turbine panels 200 may be coupled to a generator that provides AC power. The AC power may be coupled to the output of a DC-AC converter that converts the DC output of the solar panels to AC. The combined AC powers may then be fed into the structure (house or building). Such compatibilities between the phased array wind turbine panel 200 and the existing solar panels may simplify permitting of the phased array wind turbine panels 200 and help facilitate ease of installation of the phased array wind turbine panel 200 in new and existing roof panel installations. In considering whether the electrical part or mechanical part of the array panel dominates as far as efficiency, there are several possibilities. In one embodiment, it is desirable to derive electrical outputs from mechanical power directly from individual component (e.g., rotor) of the array wind turbine panel and, thereafter, combine the individual electrical outputs into a larger electrical output to be fed into the house or building. The electrical output may be alternatively be derived from mechanical power generated by a group (i.e., plurality) of individual rotors 202 of the array wind turbine panel.

Furthermore, in some embodiments of hybrid wind/solar systems, the phased array wind turbine panel 200 may generate a mechanical output that is coupled to an output of a DC motor that generates a mechanical output based on the DC power generated by the solar panels. The mechanical outputs from the phased array wind turbine panel 200 may be coupled to the output of the DC motor and fed to a generator that generates an AC power output 210 based on the combined mechanical inputs 208 from the panels of the hybrid wind/solar system. The AC power output from the generator may then feed a structure or the grid 10 (or electric vehicle, and so forth).

As described above, the rotors 202 of the phased array wind turbine panel 200 may be air-coupled or mechanically coupled, e.g., the rotors may be mechanically coupled (e.g., geared) or autonomous and air coupled. FIG. 2C shows a structural diagram for an embodiment of the phased array wind turbine panel 200 of FIG. 2A with various gearing options for mechanically coupling the rotors 202 depicted. The term “phase” used in the phased array wind turbine panel 200 generally refers to how the rotors 202 are either air-coupled and/or mechanically-linked by the mechanical gearing 206, as described herein, to rotate in the same direction. As such, and as described herein, the air- or mechanical-coupling may synchronize the rotors 202 of the phased array wind turbine panel 200, causing the rotors 202 to work constructively when generating the mechanical output that feeds the generator. By such synchronization and coupling, a wind source (for example, any breeze that passes over the phased array wind turbine panel 200) may see only a light load of a single rotor. However, the coupling ensures that the mechanical energy of all the rotors 202 in the phased array wind turbine panel 200 are captured and summed for input to the in-panel generator. This also maximizes an electrical output 210 of the phased array wind turbine panel 200 by ensuring the mechanical (input) energy 208 from all rotors 202 is converted to electrical power 210.

Various methods for mechanically coupling the multiple rotors 202 of the phased array wind turbine panel 200 to generate a single input to the generator are available. In selecting between these options, described in more detail below, efficiency, costs, and design complexity must be balanced. For example, in one option, directly coupling each of the outputs (for example, a drive shaft 3) of the rotors 202 of the phased array wind turbine panel 200 together may provide for all the rotors 202 to rotate at the same speed and at the same time. This direct coupling may be similar to a mechanically linked drive system on a tandem bicycle that turns the sets of pedals at the same rate. With the direct coupling, each rotor may rotate in the same direction and at the same rate. Such direct coupling may cause the cut-in speed for the corresponding phased array wind turbine panel 200 to be high enough to rotate all of the rotors 202 at once. However, in another option, a transmission or clutch system may be introduced to reduce the cut-in speed. With the transmission or clutch system, the mechanical outputs of each rotor may be coupled together in a manner that allows each of the rotors 202 (and the corresponding mechanical outputs) to rotate separately. The transmission or clutch system, thus, may maintain a lower cut-in speed than the directly coupled phased array wind turbine panel 200. The lower cut-in speed with the transmission or clutch system is the result of the wind input only needing to be strong enough to turn an individual rotor of the rotors 202 in the phased array wind turbine panel 200 to generate power.

One benefit of the direct coupling is that synchronizing outputs of individual rotors 202 is not complex and the direct coupling is generally mechanically simpler. In the direct coupling example, the individual rotors 202 may provide different amounts of mechanical power. The sum of the mechanical powers of all the rotors 202 of the phased array wind turbine panel 200 is the sum of the individual rotors 202′ mechanical powers. One benefit of the transmission or clutch system is that each of the rotors 202 may rotate at different speeds and even in different directions. For example, each rotor may be able to rotate in both directions (for example, clockwise and counterclockwise when viewed down a rotating axis of the rotor). This may increase the flexibility of the rotors 202 of the phased array wind turbine panel 200 as compared to the wind turbine of FIG. 1.

In some embodiments, the in-panel generator of the phased array wind turbine panel 200 is a DC generator. Solar panels generate a DC output that is generally then converted to a household compatible AC that is either consumed, stored, or sent to the grid 10. This conversion is accomplished by an inverter. The phased array wind turbine panels 200 generate an AC output. In some embodiments, this AC output is converted to DC to be compatible and combined with the solar panel DC output. The opposite nature between solar and wind panels creates a redundancy of equipment in a hybrid System. In some embodiments, the solar DC output and mechanical output from the rotors 202 may be input to an AC generator, thereby eliminating the inverter. This would mean the generator replaces the inverter, reducing costs of the panel.

### Calculating Total Output Power

As described above, the phased array wind turbine panel 200 may generate its output power based on a sum of the power from each of the rotors 202 of the panel. When calculating power generated by a system, power into the system (Pin) will equal power out of the system (Pout) less losses. For example, two 5 horsepower (HP) motors connected to a single drive will generate a 10 HP output assuming an ideal (0 loss) combiner (for example, gear unit) when the motors are synchronized. However, most combiners operate between 90 and 100% efficiently (96% on average). Thus, for the two 5 HP motors described above, the Pout would be estimated as Pout=Total Pin−losses=(5+5)−4%=9.6 HP.

As applied to the wind turbines described herein, the wind turbine of FIG. 1 may be about 35% efficient. This means that only 35% of the wind power hitting the blades of the wind turbine is converted to electrical power. The remaining 65% of the wind power is lost. Furthermore, the wind turbine of FIG. 1 may only generate power 13.5% of the time because of the high cut-in speed inherent in the wind turbine of FIG. 1 (for example, the 10-15 m/s wind speeds described above) and an inefficient wind capture design.

The phased array wind turbine panel 200 may maintain equivalent large blade length of the wind turbine of FIG. 1 because of the sum of all the individual blades as described above. At the same time, unlike the wind turbine of FIG. 1, the phased array wind turbine panel 200 may capture more wind due to the wind-collecting form-factor design of the cones that direct wind through the rotor sinks. Furthermore, as described above, the smaller rotors 202 of the phased array wind turbine panel 200 and the transmission or clutched system coupling each of the rotors 202 provides for a much lower cut-in wind speed (as low as 1 m/s). Therefore, the phased array wind turbine panel 200 may generate more wind energy more of the time as compared to the wind turbine of FIG. 1.

### Evaluation Software for Assessment

In some embodiments, a simulation software may be used to conduct a microclimate assessment to assess benefits of a phased array wind turbine panel 200 installation. In some embodiments, the assessment may be for a hybrid wind/solar system and include both a solar evaluation and a wind flow simulation. The simulation software may utilize historical data to accurately estimate and/or calculate wind speed, direction, and turbulence for the phased array wind turbine panel 200 and sunlight intensity and direction for the solar panels. In some embodiments, positioning of the panels and/or clearing of obstructions and other objects (for example, trees) to prevent blockage and falling debris may be determined equally for both panel types (wind and solar). In some embodiments, the assessment may determine the positioning best suited to a solar-only installation, a wind-only installation, or the hybrid wind/solar combination. For example, in areas that are historically overcast for much of the day but generally windy, the assessment may determine that the wind-only (no solar) option is optimal. In some embodiments, if the areas are historically windy consistently throughout the course of each day, the assessment may determine that little or no charge storage is necessary because the wind-only installation will generate power consistently throughout the day (and night).

In some embodiments, the simulation software may simulate expected wind speed, direction, and turbulence based on, at least, historical weather data. In some embodiments, the software applications may be applied to residential, commercial, and/or industrial sites to assess placement of the phased array wind turbine panel 200. In some embodiments, the software applications may account for time of day and seasonal shifts in wind patterns.

### Harvesting Low Residential Wind Speeds

As described herein, the phased array wind turbine panel 200 converts wind to electrical power. The winds (and corresponding wind speeds) described herein are generally caused by local geographic pressure anomalies. Temperatures and local topographic features in the geography influence the local pressure anomalies. As such, wind speeds exhibited in different areas (or even a single area) may fluctuate widely due to topographic features of the area as well as temperatures (for example, from day to night). Furthermore, wind speeds in different areas may also fluctuate widely for similar reasons, as temperatures vary widely across different geographic areas.

Existing residential wind power systems (for example those having similar structure to the wind turbine of FIG. 1, just smaller) may not provide power over as large a range of wind speeds as the phased array wind turbine panel 200. For example, some residential wind power systems may utilize rooftop wind turbines that are similar in design and operation to the wind turbine of FIG. 1 but have a rotor diameter of 1-5 m. In some embodiments, the power output of such rooftop wind turbines only hits the rated output of 1 kilowatt (kW) at wind speeds of about 11 m/s. As wind speeds increase, the rooftop wind turbine may apply a braking mechanism to prevent damage to the rooftop wind turbine, for example at wind speeds above 13 m/s. Thus, the range (11 m/s to 13 m/s) in which the rooftop wind turbine produces its rated output power of 1 kW is very narrow. Furthermore, an 11 m/s wind speed is generally not a normal occurrence in residential areas, meaning that such rooftop wind turbines are generally not providing output power at their rated power a majority of the time. Such aspects reduce the value of wind power investment as compared to solar and/or grid power of such roof-top wind power embodiments.

Historical records suggest that wind speeds of 3-5 m/s are much more likely in residential environments. The phased array wind turbine panel 200, as described above, may be configured to generate its rated power output at the wind speeds of 3-5 m/s, thus making the phased array wind turbine panel 200 optimal for use in residential settings.

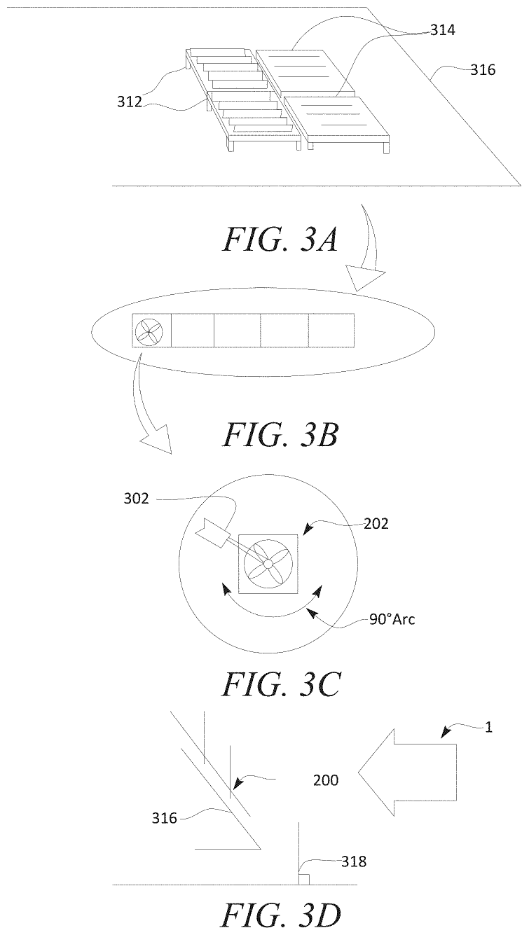

As shown in FIG. 3A, in some embodiments, the phased array wind turbine panel 200 may be mounted near a center of a roof 316 rather than along a perimeter of the roof, where turbulence may be greater. As described above, the phased array wind turbine panel 200 may mount to the roof 316 using similar hardware as roof-mounted solar panels 314. In some embodiments, the roof-mounted panels may use spacers 312 that provide a gap between the roof 316 and the panel itself. The spacers 312 are configured to provide flow of wind through, e.g., to enhance wind flow and power generation. In some embodiments, the gap provides through-flow for the phased array wind turbine panel 200. As shown in FIG. 3A, the phased array wind turbine panel 200 may be arranged to resemble stadium seating. As further shown in FIG. 3B, the rotors 202 of the phased array wind turbine panel 200 may be arranged in a plurality of rows, where each row comprises rotors 202 that are positioned upright and perpendicular to the ground for optimum wind capture by the rotors 202. FIG. 3C shows that each rotor 202 of the phased array wind turbine panel 200 may comprise an alignment tail vane 302 coupled to each rotor 202. The rotor 202 is recessed within a cone collecting form factor of the panel 200. The alignment tail vane 302 may cause the rotor to adjust direction within a 90-degree arc to capture a greater amount of the wind. The alignment tail vane 302 ensures that the rotor 202 turns within a 90-degree arc to capture prevailing wind. In some embodiments, the residential structures and the local terrain may have the greatest impact on wind speeds. As shown in FIG. 3D, the rotors 202 may be set perpendicular (angle 318) to ground for optimal capture of wind 1. The placement of the rotors 200 will account for the roof pitch 316, so the rotors 202 are substantially perpendicular to ground level.

### System Design

An average annual electricity consumption for U.S. residential homes of 10,399 kilowatt-hours (kWh) equates to about 867 kWh per month. Twenty, 50-watt lights will use 1000-watts or 1 kilowatt of power. If these lights are on for an hour, an electric company will charge a rate for 1 kilowatt-hour. As noted above, the typical photovoltaic solar panel may generate 250 watts for 4 hours per day in ideal conditions, which is an equivalent of 1 kWh per day. The average home may use 29 kilowatt-hours each day.

An amount of power generated by the solar panel may depend on a variety of factors, as described above. For example, how much sunlight the solar panel is exposed to, a solar production ratio of the solar panel installation, an angle of the solar panel on the roof, and so forth, may impact the power generated by the solar panel. The solar production ratio of the solar panel installation may vary by location of the install. For example, the solar production ratio for Arizona is 1.61 (which is the best solar production ratio in the United States) while the solar production ratio for Maine is 1.31 (which is the worst solar production ratio in the United States. The solar production ratio may be a factor in determining a number of panels needed to cover 100% of the electricity usage of the home. For example, the average installation to cover 29 kWh in California would be a 7 kW system that uses 27 solar panels. On the other hand, the average installation to cover 29 kWh in Maine would be an 8.8 kWh system that uses 33 panels.

Since solar panels may generate power for a portion of each day, solar panel systems may be over designed to generate sufficient power for the full day's electricity demands. Since the power is only generated for 4 of the 24 hours in a day, the installed system must generate an abundance of power during this 4-hour window to give to the electric grid, to compensate for the 20 hours the solar panel system not generating and the house is pulling power from the grid. The solar panel system may also be over designed because the electric company buys excess power at a fraction of the price at which the electric company sells the power back. In some embodiments, the solar panel system is coupled to the charge storage system. The charge storage system may add cost to the solar panel system but allows the storage of the excess generated power for later use. Such charge storage may help compensate for the disadvantages of the solar panel system that only generates power for about 17% of the time.

Similar to the solar panels in the solar panel system, the phased array wind turbine panels 200 described herein can be used in systems with (and can be opportunely placed alongside) solar panels to capitalize on wind speed and direction at each installation site. However, unlike the solar panels, which may be generally limited to about 17% of the day, the phased array wind turbine panels 200 can operate for upwards of 80-90% of the day, or at least as long as the wind speeds are above the cut-in speeds for the phased array wind turbine panels 200. Assuming the 80-90% operation in an average day, three phased array wind turbine panels 200 exposed to an average gentle breeze of 5 m/s may generate 60-70% of the average home's daily electricity needs. Thus, the integration of the phased array wind turbine panels 200 may allow for the solar panel system to be reduced to, for example, 4 to 5 panels to make up the difference from the phased array wind turbine panels 200. The integration of the phased array wind turbine panels 200 may also allow for use of a smaller charge storage device to handle any gaps because more power would generally be available directly from the phased array wind turbine panels 200. Such an integrated hybrid wind/solar system may be more economical than a solar panel only system and, thus, make such systems available to those with limited finances, rooftop real estate, and so forth,

### Panel Design

In designing the phased array wind turbine panel 200 for placement alongside or instead of solar panels, as described above, various factors are considered (for example, by the simulation software described herein). For example, the quantity of, size of, and spacing between the blades of the rotors 202 may be optimized to maximize efficiency, reduce cost (for example, construction and maintenance), and simplify design complexity of the phased array wind turbine panel 200. For example, the rotors 202 in the phased array wind turbine panel 200 may be designed (with regard to the quantity, size, and spacing of the rotor blades 2) to present a light load to the wind, creating a type of “butterfly effect”. In some embodiments, multiple rotors 202 (for example, a row of rotors 202, a column of rotors 202, a subset thereof, or a combination thereof) may be grouped into a module. The module may be designed to enable simplified replacement and maintenance of the phased array wind turbine panel 200. For example, FIG. 2D shows a structural diagram for an alternate embodiment of the phased array wind turbine panel 200 with five sets of replaceable multi-rotor spiral columns 218. The multi-rotor spiral columns 218 (or other module grouping) may be stacked or otherwise arranged in the phased array wind turbine panel 200.

In some embodiments, the design of the phased array wind turbine panel 200 may include a screen of low-air resistance material used to protect the rotors 202 from debris that could enter and jam the rotors 202. In some embodiments, replaceable panel sub units (for example, the rows or columns of rotors 202, as described above with reference to FIG. 2D) may reduce the number of internal parts for maintenance. In some embodiments, one or more components of the phased array wind turbine panel 200 may be placed on a shock absorbing material. The shock absorbing material may mitigate vibration and/or noise from being transmitted from the rotors 202 to the remaining components of the phased array wind turbine panel 200. In some embodiments, the low-air resistance material and/or the shock absorbing material may comprise nylon, as it is impervious to many elements and long lasting.

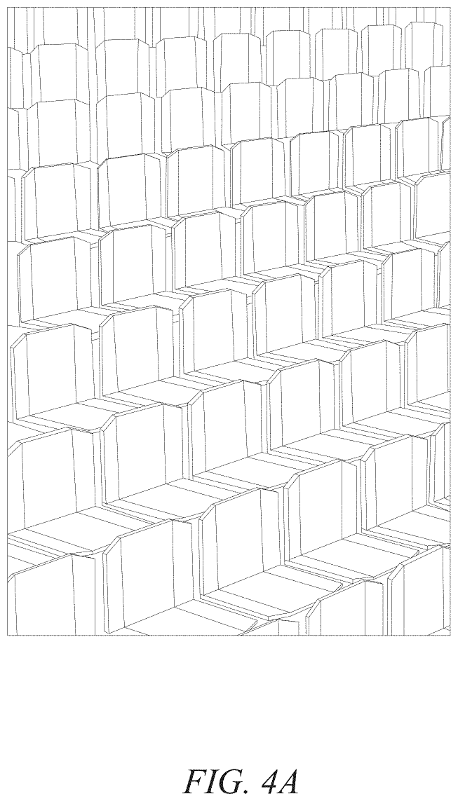

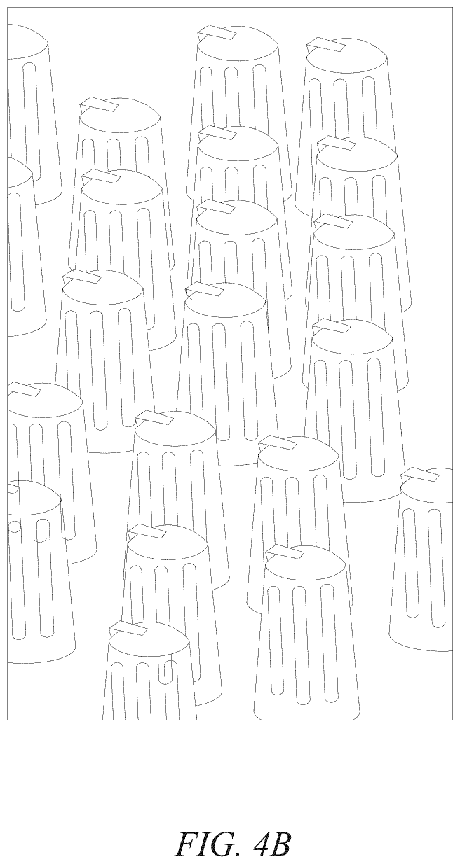

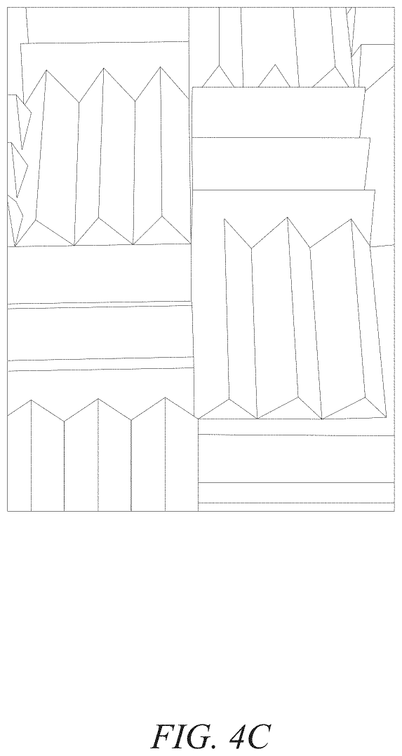

In some embodiments, the design of the phased array wind turbine panel 200 may include bidirectional or unidirectional rotors 202 grouped into a plurality of geared sub-units. In some embodiments, the sub-units (or individual rotors 202) may have combined outputs that are combined at an input of the in-panel generator. in some embodiments, the rotors 202 of the phased array wind turbine panel 200 may be arranged in one or more staircase or stadium seating sub-unit arrangements (FIG. 4A), in a vertical sub-unit arrangement (FIG. 4B), and/or a crisscross staircase sub-unit arrangement (FIG. 4C), with spiral gaps located between each rotor or group of rotors along the vertical axis (based on the column orientation shown in this figure). In particular, FIG. 4A shows a layout of a staircase or stadium seating arrangement of rotors 202 in the phased array wind turbine panel in accordance with an exemplary embodiment of the invention. FIG. 4B shows a layout of a vertical sub-unit arrangement of the rotors 202 in the phased array wind turbine panel in accordance with an exemplary embodiment of the invention. FIG. 4C shows a layout of a crisscross staircase or stadium seating arrangement of the rotors 202 in the phased array wind turbine panel in accordance with an exemplary embodiment of the invention.

In some embodiments, as described above, the phased array wind turbine panel 200 is physically and electrically compatible with existing roof-mounted solar panels. As noted above, the phased array wind turbine panel 200 utilizes the same mounting hardware and spacers as generally used for solar panel installations. The spacers may provide a gap between the roof and the phased array wind turbine panel 200 and between adjacent phased array wind turbine panels 200. The gap may provide through-flow for the phased array wind turbine panel 200.

As described herein, the phased array wind turbine panels 200 may be designed so that the wind sees a light, single rotor load. For example, as described above, the rotors 202 of the phased array wind turbine panels 200 may be mechanically coupled such that the outputs of the rotors 202 are summed without requiring all of the rotors 202 turn at the same time. Accordingly, the mechanical coupling enables to the phased array wind turbine panels 200 to harvest low wind speeds from 1-5 m/s. In some embodiments, the phased array wind turbine panels 200 may have a maximum output power (Pmax) of 250 W, a current of about 8 amps (A) at Pmax, a voltage of about 30 volts (V) at Pmax, weight of 19 kilograms (kg), and length×height×width dimensions of 1665 mm×50 mm×991 mm.

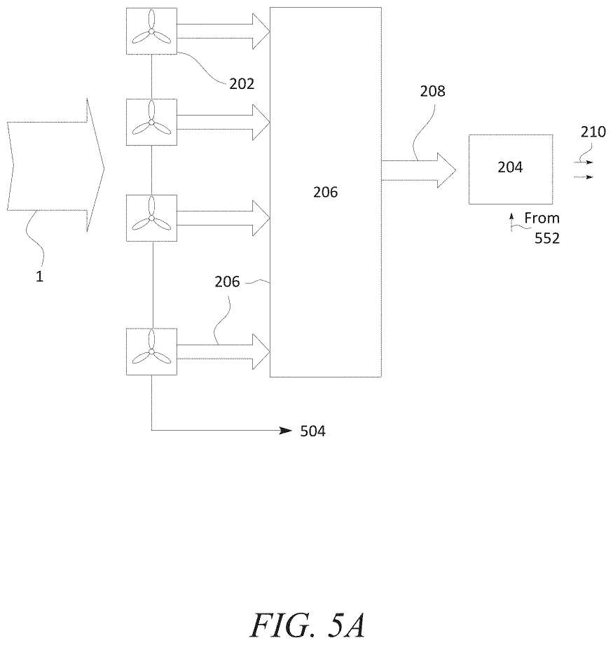

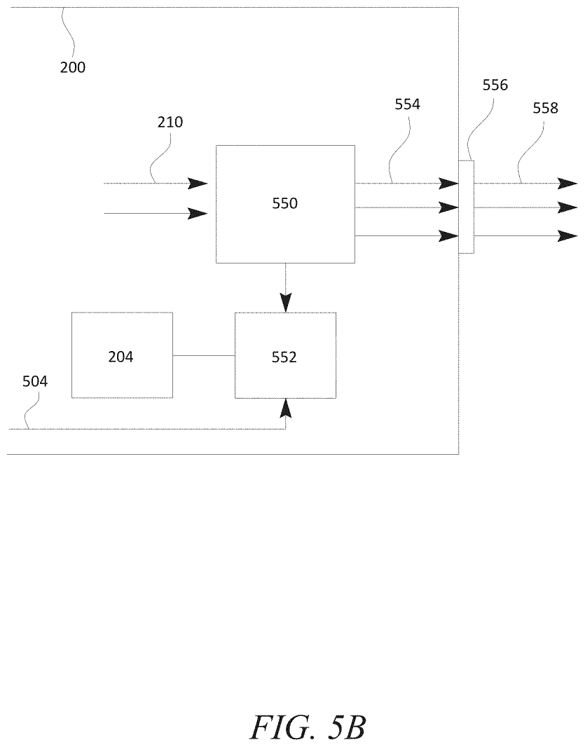

FIG. 5A is a structural diagram that shows the mechanical components of the phased array wind turbine panel 200 of FIG. 2A. The wind 1 turns the individual rotors 202 in the phased array wind turbine panel 200, and the mechanical energy from each of the individual rotors 202 is combined in a power transmission gearbox. The power transmission gearbox 206 generates a total mechanical output 208, which is used to drive the input of a generator 204 that produces an electrical energy output 210. The electrical energy output 210 may be processed by a power management and control unit (550 of FIG. 5B) via a control 502. The electrical energy output 210 may be AC or DC and may be available at a junction box of the phased array wind turbine panel 200. This output may be combined with outputs from other wind and solar panels for aggregation and conversion, etc., for supply to homes/grid. As noted above, the outputs maybe combined in electrical (e.g., current) form to produce a larger electric output. A wind sensor (for example, one of the rotors 202) that monitors a sensed wind speed and generate a wind sensor output 504.

FIG. 5B is a block diagram that shows exemplary electrical components of the phased array wind turbine panel 200 of FIG. 2A. The electrical components of the phased array wind turbine panel 200 may include a wind sensor (for example, one of the rotors 202) that monitors a sensed wind speed and generate the wind sensor output 504 of FIG. 5A. In some embodiments, the sensed wind speed is monitored by a jump-start control unit 552. The phased array wind turbine panel 200 may have a jump-start option, in which one of the rotors 202 may be used as a wind sensor or an independent wind sensor may be used to generate a wind sense input 504 to the jump-start control unit 552. If the wind exceeds a given speed to warrant setting all the rotors 202 into motion, the jump-start control unit 552 may switch the generator to a motor function 210. The power management and control unit 550 may deliver electrical energy to the generator that is now operating as a motor, producing a mechanical output to the power transmission gearbox that in turn will drive all of the individual rotors 202 setting them into motion. Once the rotors 202 are in motion, the generator may switch to a generator function and generate an electrical output 210 based on the wind driving the rotors 202, to deliver power 504 to a panel junction box 556, which in turn deliver power to a home inverter 558.

### Corresponding Calculations

Coupling of Rotors 202

In general, in a system of rigid bodies constrained to rotate at same or similar speeds, the inertias and the torques acting on the rigid bodies (for example the rotors 202 of the phased array wind turbine 200) can be added together according to Equation #1:

$${\sum }_{i} {τ}_{i} = \dot{ω} {\sum }_{i} {I}_{i}$$

Where τᵢ represents a torque acting on a system of the rigid bodies for example, the torque produced by a rotor of the panel of rotors 202 or the resistance of a rotor by the wind). In some embodiments, the system may be modeled as Equation #2:

$${τ}_{i} + {\sum }_{j} {τ}_{ij} = {\dot{ω}}_{i} {I}_{i}$$

Where τᵢⱼ is an anti-symmetric matrix representing the torque at an interface between components i and j. For example, sprag clutches (for example, a one-way freewheel clutch) may mechanically couple the rotors 202 and ensure that torque between rotors 202 of the panel cannot be negative (ideally). However, in reality, a small drag (negative torque) may exist for one or more rotors 202.

A processor (for example, the processor on which the simulation evaluation software runs) may calculate accelerations for each of the rotors 202 of the panel based on Equation #1, The processor may then use Equation #2 to determine the torque on the respective clutches. If the torque is negative for one rotor, then that rotor would no longer be constrained to rotate at the same speed as the remainder of the rotors 202 having positive torque values. That means that that particular rotor (having the negative torque) may not be included in the summing of the torques per Equation #1. The clutch for that rotor may disengage so that that rotor does not impede the production of the remaining rotors 202. The processor may then reevaluate Equation #1 for the rotors 202 of the panel excluding the rotor(s) having the negative torque value(s) on or at their respective clutch(es). Then, the processor may use Equation #1 on just the rotor(s) having the negative torque value(s) to determine rotor acceleration.

If rotational velocity of one rotor exceeds that of the rest of the rotors 202 of the panel, then the corresponding clutch would reengage, constraining the rotor velocities together. Thus, the panel (and the corresponding rotors 202) can be treated like a system again. The clutches may bring all the rotors 202 of the system to the same or similar rotational velocity and the processor could use Equations #3 and #4 below to calculate an inertia weighted average of rotational velocity for the panel.

If some ridged bodies (for example, rotors 202) are constrained to rotate at a speed proportional to each other (for example, though one or more mechanical gears), the processor can apply the same equation, but the inertia, torques, and speeds must be multiplied/divided by a corresponding gearing ratio.

$$\begin{matrix}{ω}_{i} = {r}_{i} ω & Equation \#3 \\ {\sum }_{i} {τ}_{i} {r}_{i} = \dot{ω} {\sum }_{i} {I}_{i} {r}_{i} & Equation \#4\end{matrix}$$

A typical rooftop solar panel may have a corresponding power rating. The power rating for the solar panel may indicate how much power the solar panel will generate during ideal conditions (typically 250 W). The power rating is generally measured under Standard Test Conditions (STC), in which labs test the panel under ideal conditions (called “peak sun” conditions) where the panel is assumed to receive 1000 W of sunlight per square meter of solar panel surface. The peak sun conditions are approximately equivalent to the power received from the sun at noon, on a sunny day, on the equator. Such ideal conditions are not generally replicable in the “real world”. Equation #5 below can calculate and/or estimate the annual energy output of a photovoltaic solar panel installation:

E=A*r*H*PR

### Where:

E=Energy (kWh).
A=Total solar panel Area (m²).
r=solar panel yield or efficiency (%), given by the ratio: electrical power (in kW-peak) of one solar panel divided by the area of the panel. For example, the solar panel yield of a photovoltaic module of 250 Watts-peak with an area of 1.6 m² is 15.6%.
H=Annual average solar radiation on tilted panels (shadings not included). A value for H may fall within a described range, for example, between 200 kWh/m2 (the annual average solar radiation in Norway) and 2600 kWh/m² (the annual average solar radiation in Saudi Arabia). Solar radiation databases may provide the global annual radiation incident on solar panels with a specified inclination (for example slope, tilt, and so forth) and orientation (azimuth) in a given location.
PR=Performance ratio, coefficient for losses (range between 0.5 and 0.9, default value=0.75). PR may evaluates the quality of a photovoltaic solar panel, giving the performance of the installation independent of the orientation, inclination of the panel. The performance ratio includes all losses. For example, losses incorporated into the PR value (depends on the site, the technology, and sizing of the system) include:
   Inverter losses (4% to 10%).
   Temperature losses (5% to 20%).
   DC cables losses (1 to 3%).
   AC cables losses (1 to 3%).
   Shadings 0% to 80% (specific to each site).
   Losses at weak radiation 3% to 7%.
   Losses due to dust, snow, and so forth (2%).

### Rotor Blade Design

A tip-speed ratio (TSR) for the rotor of the phased array wind turbine panel 200 generally refers to a ratio between the tangential speed of the tip of a blade of the rotor and the actual wind speed driving the rotor. Slow turning rotors 202 have tip speed ratios of 1-4, whereas fast turning rotors 202 have a tip speed ratio of 5-7. The rotors 202 in the phased array wind turbine panel 200 may be designed to spin at varying speeds. The rotors 202 may have a low rotational inertia, meaning the rotors 202 can accelerate quickly, thereby improving energy capture from sudden gusts that may occur.

As described above, wind power intercepted by the rotor is proportional to the square of the rotor's blade length, and so the longer the blade, the better the power intercepted. However, a larger blade length also increases the cut-in speed of the rotor, noise by the rotor, and stress on the system and panel. As described herein, for the phased array wind turbine panel 200 to harvest the low wind speeds found in many environments, the phased array wind turbine panel 200 is designed, in one embodiment, with the array of coin-sized rotors 202 coupled to work collectively. Such a phased array wind turbine panel 200 provides the high performance of a large turbine without the corresponding noise and stress.

The in-panel (or external) generator's capacity and revolutions should match the wind speed and the swept rotor area. Equation #6 provides for a total power generated by the rotor:

Power (W)=0.6×Cₚ×N×A×V³

### Where:

Cₚ is Rotor efficiency (Rotor efficiency can go as high as 0.48, but 0.4 is often used in these type of calculations).
N is Efficiency of mechanical drive from all of the rotors 202 in the array to generator input (the transmission will typically have an efficiency of 0.95, and so N=0.95×0.7).
A is Swept rotor area (m²),
V is Wind speed (m/s),

Equation #7 provides for a number of revolutions by the rotor:

Revolutions (rpm)=V×TSR×60/(6.28×R)

### Where:

TSR is Tip Speed Ratio,
R is Radius of rotor.

As an example, assume a TSR of 7, a Wind speed, V of 8.6 m/s, a Rotor efficiency, Cp of 0.4, a Generator efficiency, N of 0.7, a Swept rotor area, A of 2.11 m² (panel), a radius of combined panel rotors 202 of 0.82 m, and Revolutions of 701 rpm. The resulting Power output will equal 226 W. The width of the blade of the rotor (also called the blade chord), is computed using Equation 8:

Blade Chord (m)=5.6×R²/(i×Cl×r×TSR²)

### Where:

R is Radius at tip,
r is radius at point of computation,
i is number of blades,
Cl is Lift coefficient,
TSR is Tip Speed Ratio.

### Calculating Wind Power

The power output of a wind generating system is proportional to twice the area swept by the rotors 202 of the system. Accordingly, doubling the swept area doubles the power output. Using the phased array wind turbine panels 200, increasing the swept area means adding more phased array wind turbine panels 200.

The power output of a wind generator is also proportional to the cube of the wind speed, and kinetic energy from wind can be calculated using Equation #9:

Kinetic Energy=0.5×Mass×Velocity².

### Where:

Mass is measured in kg,
Velocity in m/s,
Energy is given in joules.

Air has a known density (approximately 1.23 kg/m³ at sea level). Thus, the mass of the air hitting the phased array wind turbine panel 200 each second is given by the following Equation #10:

Mass/sec (kg/s)=Velocity (m/s)×Area (m²)×Density (kg/m³)

An amount of energy transferred by the wind to the rotors 202. is not only dependent on the density of air, the cumulative rotor size, and the wind speed. The kinetic energy of all the array's bodies-in-motion is proportional to the mass of the bodies-in-motion, so that kinetic energy depends on the density of air. Accordingly, the “thicker” the air, the more energy is obtained from the wind panel array. The density of air is dependent on the amount of molecules per unit volume of air. With normal air pressure at a temperature of 15° C., the mass of air is 1.2 kg/m³. However, with an increase of a moisture content, the density of air decreases. At a constant temperature, more water vapor in air will displace other gases, making the air less dense. Colder air is denser than warmer air, so at the same speed of wind, a phased array wind turbine panel 200 produces more electricity in winter than in summer (which is the complete opposite, and complementary, to energy production by the solar panel).

Therefore, the power of the wind (energy per second) hitting the phased array wind turbine panel 200 with a certain area (of rotors 202) is given by inserting the mass per second calculation into the standard kinetic energy equation given above resulting in the following Equation #11;

Power=0.5×Swept Area×Air Density×Velocity³

### Where:

Power in Watts (joules/second),
Swept area in square meters,
Air density in kilograms per cubic meter,
Velocity in meters per second.
Wind power (P) is calculated using Equation #12;

P=0.5×ρ×A×Cp×V³×Ng×Nb

### Where:

ρ is Air-density (kg)/m3,
A is Rotor swept area (m2),
Cp is Coefficient of performance,
V is wind velocity (m/s),
Ng is generator efficiency,
Nb is gearbox-beating efficiency.

### Electrical Model

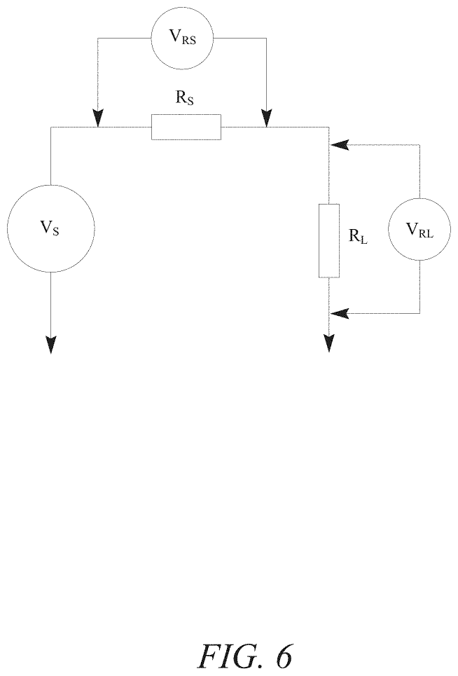

FIG. 6 is a circuit diagram representing the panel generator electrically, where Rs is the resistance of the generator windings plus the power cable, and RL is the resistance of the load. Power generated by the blades (source) can be calculated with Equation #13:

Vs=VL×[(Rs+RL)/RL]

Power produced by the blades, and lost in the generator, power cable and resistor load is given by Equations #14 and #15:

P=V²/R

P=Vs²/(Rs+RL)

The math modeling and design of the phased array wind turbine panels 200 take into account environmental factors like wind direction change, corrosion, water vapor intrusion, thermal expansion, mechanical load changes, summer-winter climate changes, aging and component degrading. in one embodiment, it is desirable to create a nonlinear resistance whereby near no resistance is experienced at start up and then the resistance and so power generation increases exponentially with speed of the rotor. This nonlinearity in resistance may be accomplished by using generator magnets. [NIGEL, please explain use of magnets here].

An example solar panel is installed in Great Britain. In Great Britain, 48% of the days per year are overcast. In the winter, the sun rises later and sets earlier, so the mornings are dark and the nights drawn in. With fewer daylight hours (as compared to other times of the year), energy generation levels by the solar panel may be reduced (as compared to the other times of the year). Thus, during the winter months, the solar panel may produce less energy compared to what it may produce during the summer months, where daylight hours are longer. Although Europe has some of the cloudiest cities in the world, some US cities average less than 2,500 hours of sunshine annually. For example, Pittsburgh, Pa. tops the list of the cloudiest cities in the US. Pittsburgh averages less than 2,100 (approximately 2,021) hours of sunlight annually. Thus, generally, it is cloudy in Pittsburgh for 77% of the year.

Partial cloud cover is described as cloud covering from over one-quarter to as much as three-quarters of the sky. When days with partial cloud are added to the days of heavy cloud, to include every day that cloud covers more than one-quarter of the sky, then Buffalo, N.Y. averages 311 days of cloud cover a year, slight more than the 308 days of cloud cover in Seattle, Wash. Houston, Tex. has the lowest average number of partially cloudy days at 114 partially cloudy days per year.

There are several factors throughout the year accounting for why the power output of a solar panel may be less than the rated 250 watts. First, ideally, the solar panel would be installed to be perpendicular to the angle of the sun as this provides the highest energy output by the solar panel. The angle of the sun changes by about 15 degrees from summer to winter and this can reduce energy production by up to 50% for the winter months, a 35% annual decrease. Output power from the solar panel may be further reduced to as low as 50% on a partially cloudy day and on an overcast day power output could be as little as 10%. These losses, coupled with the very small window of opportunity, may account for why a larger number of panels is generally needed for a typical solar panel installation.

### Scalability

The phased array wind turbine panel 200 may be scalable in size. For example, the phased array wind turbine panel 200 may be shrunk from the rooftop panel size to a smaller panel size (for example, as small as a credit card). In some embodiments, the smaller sized (for example, the credit card sized) or mini-panel may be hermetically sealed and comprise a plurality of geared, unidirectional rotors 202 that drive a combiner, an internal micro-dynamo, and regulator (together similar to the in-panel generator described above). In some embodiments, one or more of the combiner, internal micro-dynamo, and regulator may be disposed on a pouch (or similar structure) on a back of side of the mini-panel. Thus, the pouch may accommodate components and serve as a stand for the mini-panel. In some embodiments, the mini-panel may provide a connector (for example, a universal system bus (USB) compatible socket). In some embodiments, the mini-panel further comprises an light emitting diode (LED) bar graph display to display various information which is bypassed if a load is connected to the connector. In some embodiments, the connector may provide sufficient power to charge a mobile device with an output of, for example, 5V at 100 mA.

In other embodiments, the phased array wind turbine panel 200 may be expanded in size and may be larger than a typical rooftop solar panel size.

### Environmental Benefits

In some embodiments, the solar panels create 300 times more toxic waste per unit of energy produced than do nuclear power plants. Thus, if solar panels and nuclear power plants produce the same amount of electricity over the next 25 years, the wastes from these sources would be drastically different. For example, when stacked on football fields, the nuclear waste would reach the height of the Leaning Tower of Pisa (52 meters), while the solar waste would reach the height of two Mt. Everests (16 km).

In some countries (for example, China, India, and Ghana), communities living near e-waste dumps may burn the waste in order to salvage the valuable copper wires for resale. Since this process requires burning off the plastic, the resulting smoke contains toxic fumes that are carcinogenic and teratogenic (birth defect-causing) when inhaled. Solar waste outside of Europe today ends up in the larger global stream of electronic waste. Solar panels contain toxic metals such as lead, which can damage the nervous system, as well as chromium and cadmium, known carcinogens. All three are known to leach out of existing e-waste dumps into drinking water supplies.

### Efficiency Benefits

As described above, the phased array wind turbine panel 200 may generate power for more a majority if not all of the 24 hours of each day. The typical rooftop solar panel, as described herein, may only generate substantial power for a portion of each day (and based on an efficiency heavily dependent on cloud cover, the sun's seasonal angular change, and so forth). Thus, over the course of time, the phased-array wind turbine panel 200 may generate 10 times the power of the same-sized solar panel at 1/10th the cost of the same-sized solar panel. The phased array wind turbine panel 200 may generate power all through the day and all through the night, regardless of cloud cover and/or season.

### Further Particular Characteristics

In some embodiments, the phased array wind turbine panel may use an array of smaller wind turbines operating in combination to have an equivalent large blade length, as wind power intercepted is proportional to the square of its blade length.

In some embodiments, the phased array wind turbine panel may use an array of smaller wind turbines operating in combination that will have a lower cut-in speed and so harvest lower speed wind energy.

In some embodiments, the phased array wind turbine panel may include a component that acts as a sail to capture more wind than the blades of a turbine.

In some embodiments, the phased array wind turbine panel may use a cone-collecting form-factor panel design that directs wind through the rotor sinks.

In some embodiments, the phased array wind turbine panel may optimize the rotor size and the gap between rotors 202 to maximize efficiency of the panel.

In some embodiments, the phased array wind turbine panel may optimize the size, number, and the gap between the blades of the rotors 202 for peak efficiency.

In some embodiments, the phased array wind turbine panel may optimize the rotor design to enable activation from a wide arc, both forward and reverse, to capture wind shifts that change from day to night and from season to season.

In some embodiments, the phased array wind turbine panel may use material science to find a durable, all-weather, low cost and simplified design solution.

In some embodiments, the phased array wind turbine panel may use material science to find self-cleaning materials for the panel and rotors 202.

In some embodiments, the phased array wind turbine panel may use material science to buffer the rotors 202 and moving mechanical parts to null sound and vibration.

In some embodiments, the phased array wind turbine panel may use an array gearing system between the array of rotors 202 to present a light load to the intercepting wind to generate energy at very low wind speeds.

In some embodiments, the phased array wind turbine panel may use an array gearing system to enable bi-directional wind capture so that an array can generate energy from updraft or downdraft.

In some embodiments, the phased array wind turbine panel may use an array gearing system to process clockwise and counter-clockwise motion inputs to present a sum mechanical output of a generator.

In some embodiments, the phased array wind turbine panel may use power management electronics to process clockwise and counter-clockwise mechanical inputs from the array to an AC or DC generator.

In sonic embodiments, the phased array wind turbine panel may use power management electronics and charge storage to provide load isolation so the generator does not load the array source.

In some embodiments, the phased array wind turbine panel may use power electronics to make the output of one panel operate cooperatively with more wind panels.

In some embodiments, the phased array wind turbine panel may use power electronics to provide a compatible input to a solar systems inverter.

In some embodiments, the phased array wind turbine panel may use power management electronics to reverse power when signaled to have the generator function as a motor to jump-start the array into motion.

In some embodiments, the phased array wind turbine panel may use information processing electronics to sense wind of a certain magnitude and for a certain time to activate a jump-start.

In some embodiments, the phased array wind turbine panel may use a wind sensor or a rotor as a wind sensor to measure wind speed and duration.

In some embodiments, the phased array wind turbine panel may group of more than one rotors 202 in a self-contained module that makes for easy maintenance replacement.

In some embodiments, the phased array wind turbine panel may use an alignment turn vane behind each rotor to adjust direction within an arc to capture a greater amount of prevailing winds.

As used herein, “system,” “instrument,” “apparatus,” and “device” generally encompass both the hardware (for example, mechanical and electronic) and, in some implementations, associated software (for example, specialized computer programs for graphics control) components.

The various embodiments of interactive and dynamic safe zone generation and control of the present disclosure are the result of significant research, development, improvement, iteration, and testing. This non-trivial development has resulted in the methods and processes described herein, which may provide significant efficiencies and advantages over previous systems. The interactive and dynamic user interfaces include efficient human-computer and computer-computer interactions that may provide reduced workloads, accurate predictive analysis, and/or the like, for a user. For example, access to user information for entities may be automated such that the user is not prompted to provide authentication information when the user is in a safe zone, thereby enabling a user to more quickly access, navigate, participate in, and conclude a transaction (such as image processing) than conventional systems.

Further, the data processing and interactive and dynamic user interfaces described herein are enabled by innovations in efficient data processing and interactions between the user interfaces and underlying systems and components.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described herein generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various features and processes described herein may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various illustrative logical blocks and modules described in connection with the embodiments disclosed herein can be implemented or performed by a machine, such as a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some, or all, of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As used herein a “data storage system” may be embodied in computing system that utilizes hard disk drives, solid state memories and/or any other type of non-transitory computer-readable storage medium accessible to or by a device such as an access device, server, or other computing device described. A data storage system may also or alternatively be distributed or partitioned across multiple local and/or remote storage devices as is known in the art without departing from the scope of the present disclosure. In yet other embodiments, a data storage system may include or be embodied in a data storage web service.

As used herein, the terms “determine” or “determining” encompass a wide variety of actions. For example, “determining” may include calculating, computing, processing, deriving, looking up (for example, looking up in a table, a database or another data structure), ascertaining and the like. Also, “determining” may include receiving (for example, receiving information), accessing (for example, accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (for example, transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), ADOBE® FLASH®, JAVA®, MICROSOFT® .NET®, web services, and rich site summary (RSS). In some implementations, a UI may be included in a stand-alone client (for example, thick client, fat client) configured to communicate (for example, send or receive data) in accordance with one or more of the aspects described.

Disjunctive language such as the phrase “at least one of X, Y, or Z,” unless specifically stated otherwise, is otherwise understood with the context as used in general to present that an item, term, and so forth, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

All of the methods and processes described herein may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the herein-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated herein, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Those of skill in the art would understand that information, messages, and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

What is claimed is:

1. A system for generating power from wind, the system comprising:
an array of rotors exposed and configured to capture wind power, the array of rotors installed or set in a rotor panel having members that carries each of rotor of the array of rotors in a freewheeling state;
a generator connected to a subset of the rotors of the array of rotors and configured to generate electric power from the subset of the rotors when the rotors rotate at a speed exceeding a threshold rotational speed; and
a converter connected to an output of the generator and configured to convert the electric power into another electric power suitable for transmission to and consumption by an electric consumer.

2. The system of claim 1, wherein the subset of the rotors comprises a single rotor.

3. The system of claim 1, further comprising a conical structure located within proximity and configured to collect and channel or direct wind to at least one of the rotors in the array of rotors.

4. The system of claim 1, further comprising a mechanical gearing system configured to mechanically-link all rotors of the array of rotors to rotate the rotors in the same direction.

5. The system of claim 4, wherein the mechanical gearing system operates within the array of rotors to present a relatively lighter load to the intercepting wind causing generation of energy at wind speeds that are lower than without the mechanical gearing system.

6. The system of claim 4, wherein the gearing system is configured to enable bi-directional wind capture so that the array of rotors generates energy from updraft or downdraft of wind.

7. The system of claim 1, wherein the rotor panel operate the array of rotors as wind turbines each having a first blade length that is equivalent to a single wind turbine have a second blade length that is larger than the first blade length, and wherein the wind power intercepted by each wind turbine is proportional to the square of the first blade length.

8. The system of claim 1, wherein a size, gap distance separating each from one another, and number of blades for each rotor are optimized to maximize efficiency of the panel.

9. The system of claim 1, further comprising a power management system to convert clockwise and counter-clockwise mechanical outputs from the array of rotors to an AC or DC generator.

10. The system of claim 1, further comprising a power management system to store energy and provide load isolation so the generator does not load the wind source wherein the array of rotors comprise material that is activated periodically to self-clean blades and axis of rotation of the rotors.

11. The system of claim 1, further comprising power electronics to provide a compatible input to a solar system's inverter.

12. The system of claim 1, further comprising power management system configured to reverse power when signaled to have the generator function as a motor to jump-start the array of rotors into motion.

13. The system of claim 1, further comprising a sensor device configured to sense wind speed at or below a threshold magnitude and for or above a threshold duration of time to activate the generator to provide a jump-start power to the array of rotors.

14. The system of claim 1, wherein a subset of the array of rotors is integrated in a modular form factor for easy replacement.

15. The system of claim 1, further comprising an alignment turn vane located behind each rotor of the array of rotors that is configured to adjust direction of each rotor within a geometric arc to increase capturing an amount of prevailing winds.

16. The system of claim 1, further comprising a solar panel configured to generate further electric power from solar energy, wherein the converter is configured to combine the electric power generated from both the solar panel and the rotor panel.

17. A method of generating power from wind, the method comprising:
exposing an array of rotors to capture wind power, the array of rotors installed or set in a rotor panel having members that carries each of rotor of the array of rotors in a freewheeling state;
generating from a subset of the rotors of the array of rotors electric power when the rotors rotate at a speed exceeding a threshold rotational speed; and
converting the electric power into another electric power suitable for transmission to and consumption by an electric consumer.
